(19) United States
(12) Patent Application Publication
(10) Pub. No.: US 2015/0295957 A1
(43) Pub. Date: Oct. 15, 2015

(54) DATA TRANSMITTING DEVICE, DATA TRANSMITTING METHOD, AND COMMUNICATION DEVICE

(71) Applicant: KABUSHIKI KAISHA TOSHIBA, Tokyo (JP)

(72) Inventors: Yuta KOBAYASHI, Kawasaki Kanagawa (JP); Kensaku YAMAGUCHI, Kawasaki Kanagawa (JP); Shingo TANAKA, Yokohama Kanagawa (JP); Yasumichi HASHI, Fuchu Tokyo (JP)

(21) Appl. No.: 14/677,267

(22) Filed: Apr. 2, 2015

(30) Foreign Application Priority Data
Apr. 10, 2014 (JP) 2014-081278

(51) Int. Cl. H04L 29/06

(52) U.S. Cl. CPC H04L 65/1069

(57) ABSTRACT

According to one embodiment, a data transmitting device communicates with a plurality of other communication devices through a network. The data transmitting device includes a session manager and a communication processor. The session manager sequentially and cyclically selects a plurality of sessions relevant to the other communication devices. The communication processor performs a transmitting process of data to the other communication device relevant to the session selected by the session manager in each time each of the sessions is selected so as to suppress variations in amounts of transmitted data among the sessions with respect to an amount of data transmitted per one transmitting process.

### CROSS-REFERENCE TO RELATED APPLICATIONS

This application is based upon and claims the benefit of priority from Japanese Patent Application No. 2014-081278, filed Apr. 10, 2014; the entire contents of which are incorporated herein by reference.

### FIELD

Embodiments described herein relate to a data transmitting device, a data transmitting method, and a communication device.

### BACKGROUND

In communication devices installed in server devices and terminal devices, Ethernet®, IEEE 802.11a/b/g/n/ac, or the like is typically used as a protocol of the MAC layer and the physical layer. Protocols for upper layers typically include TCP/IP, UDP/IP, or the like. TCP/IP and UDP/IP are widely used in the Internet and the like. Currently, 1 Gbps Ethernet is the mainstream, and 10 Gbps Ethernet comes into use in data centers and the like. In addition, the specification design of next-generation 40 Gbps/100 Gbps Ethernet is completed. Also in IEEE 802.11, the use of some 100 Mbps to some Gbps Ethernet is supposed to steadily come into widespread use in the future.

With the widespread use of such high-speed networks, processing loads on host CPUs that control the networks increase. To reduce the processing loads on the host CPUs, dedicated hardware such as a TCP/IP Offload Engine (hereafter, referred to as TOE) has been used. The TOE is a device including a dedicated processor or a dedicate circuit that performs the process of the above-described TCP/IP on behalf of the host CPU, offloading the loads of the TCP/IP process from the host CPU. Using this TOE enables performing the TCP/IP process faster than protocol handling by conventional software.

In a transmitting process using a typical TOE, a host CPU or the like writes data to be transmitted in a transmit queue, and the TOE reads the data from the transmit queue, performs a process such as creating a header, and transmits the data to a network. At this point, the TOE processes the data in an order in which the data is written in the transmit queue.

A server device provided with such a TOE is assumed to be connected to TCP sessions of the order of some ten thousands simultaneously, and is therefore expected to have an ability to process the sessions equally. Unfortunately, in the conventional arts, the result of task scheduling on a host side may cause data in the same session to be continuously written in the transmit queue, resulting in burst transmission of frames in the same session.

### BRIEF DESCRIPTION OF THE DRAWINGS

FIG. 1 is a block diagram showing a communication device including a data transmitting device according to a first embodiment;

FIG. 2 is a state transition diagram of a session according to the first embodiment;

FIG. 3 is a flow chart showing the operation of the first embodiment;

FIG. 4 is a block diagram showing a communication device including a data transmitting device according to a second embodiment;

FIG. 5 is a state transition diagram of a session according to the second embodiment;

FIG. 6 is a flow chart showing the operation of the second embodiment;

FIG. 7 is a block diagram showing a communication device including a data transmitting device according to a third embodiment;

FIG. 8 is a state transition diagram of a session according to the third embodiment; and

FIG. 9 is a flow chart showing the operation of the third embodiment.

### DETAILED DESCRIPTION

According to one embodiment, a data transmitting device communicates with a plurality of other communication devices through a network. The data transmitting device includes a session manager and a communication processor.

The session manager sequentially and cyclically selects a plurality of sessions created for the other communication devices.

The communication processor performs a transmitting process of data to the other communication device relevant to the session selected by the session manager in each time each of the sessions is selected so as to suppress variations in amounts of transmitted data among the sessions with respect to an amount of data transmitted per one transmitting process.

Hereinafter, embodiments of the present invention will be described with reference to the drawings.

### First Embodiment

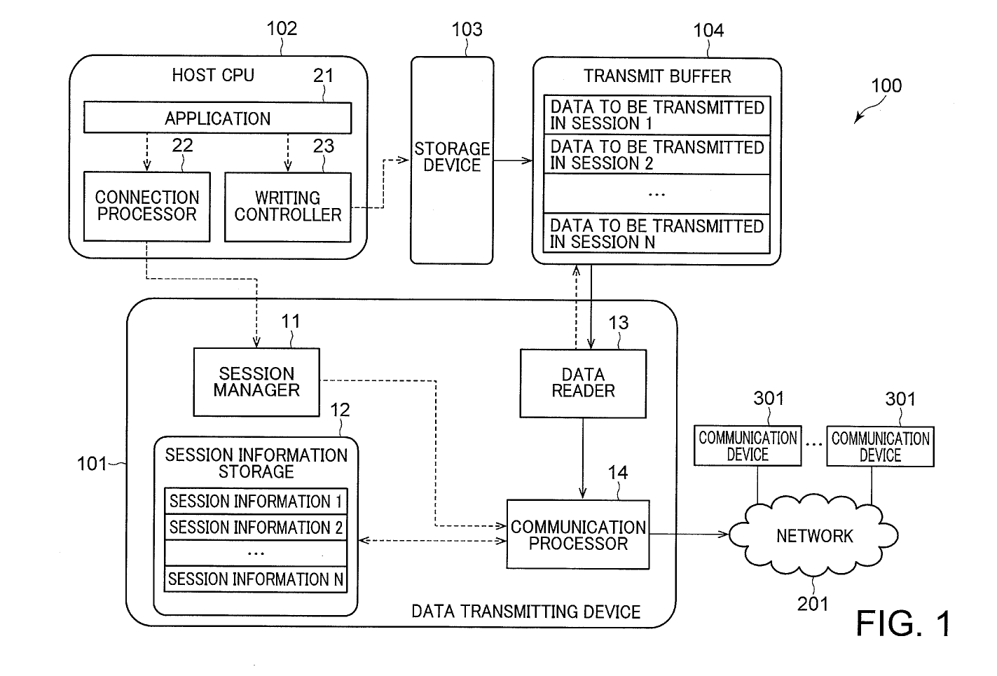

FIG. 1 is a block diagram showing a communication device including a data transmitting device according to a first embodiment. Arrowed solid lines in the drawing represents flows of data to be transmitted to a network, and arrowed broken lines represents control flows, or information other than the data to be transmitted to the network.

A communication device 100 shown in FIG. 1 is connected to one or more other communication devices 301 through a network 201. The network 201 is a wireless network, a wired network, or a hybrid network of them, for example, the Internet.

The communication device 100 creates a session with each other communication devices 301 according to a communication protocol such as TCP, and communicates therewith based on the created session. In one example, this communication device is a server device that provides data such as an image, voice, video, and text in response to a request from the other communication device 301. This is not intended to limit the form of the communication device, and may be a user terminal such as a smartphone, PC, tablet, and portable terminal as long as it is a device that creates a session with the other communication device 301. Specific product forms of the communication device include the server device, PC, and the like, as well as a dedicated LSI, a FPGA (Field Programmable Gate Array), and the like, but are not limited to them.

The other communication devices 301 may be user terminals such as smartphones, PCs, tablets, and portable terminals, or may be domestic home appliances. The other communication device 301 may be any device as long as it creates a session with the communication device 100 and receives the data provision from the communication device.

The communication device in FIG. 1 includes a data transmitting device 101, a host CPU (processor) 102, a storage device 103, and a transmit buffer 104. The host CPU 102 performs a control so as to read data to be transmitted for each session from the storage device 103 and write the data to the transmit buffer 104. In addition, the host CPU 102 controls establishing/disconnecting the connection to the other communication device for each session. The data transmitting device 101 repeats cyclically selecting each of sessions the connection of which is established by the host CPU 102 and performing a transmitting process in the selected session. In the transmitting process, data is transmitted to the other communication device for which the session is created. The data transmitting device 101 transmits the data in such a manner as to suppress the variations in the amounts of data to be transmitted among the sessions in each transmitting process. This provides equal opportunities to the sessions and allows the sessions to equally use the bandwidth of the network.

The storage device 103 stores the data to be transmitted. Possible specific installation forms of the storage device 103 include, for example, an SSD (Solid State Drive), an HDD (Hard Disk Drive), an SD card, and an SDRAM, and are not limited to them.

The transmit buffer 104 is a storage area that temporarily holds data. The transmit buffer 104 may include an area that is allocated to be used for each session. The transmit buffer 104 may be disposed in the storage device 103, or in the other device such as a main memory. Alternatively, the transmit buffer 104 may be disposed in the data transmitting device 101, which will be described hereafter.

The host CPU 102 performs the whole control of the communication device 100. The host CPU 102 includes, as software-realized main processors an application 21, a connection processor 22, and a writing controller 23. The application 21 is a processor that executes a data transmitting application.

The connection processor 22 creates a session with the other communication device 301 according to a communication protocol to be used (assuming here TCP/IP), and performs a process of establishing/disconnecting a connection to communicate with the other communication device 301 in the session. The connection processor 22 assigns a unique ID to the created session. This ID is called a session ID. The connection processor 22 communicates a control packet to establish/disconnect the connection, with the other communication device 301 via the communication processor 14 of the data transmitting device 101. Examples of the control packet include a SYN packet and FIN packet, and packets communicated accompanying these packets.

When establishing/disconnecting the connection, the connection processor 22 notifies the establishing/disconnecting the connection to the session manager 11 of the data transmitting device 101. At this point, the session ID of the established/disconnected connection is notified. The notification of the establishment of the connection may occur when data to be transmitted is first generated in the connection, or when the data is written in the transmit buffer 104 under the control of the data writing controller 23, which will be described hereafter.

Here, a session in TCP/IP refers to a connection that is managed using four pieces of information: a destination IP address, source IP address, destination port number, and a source port number. Creating a session is equivalent to create a set of these four pieces of information. Any one session has a state that the connection is established, or a state that the connection is not established (is disconnected). The TCP/IP is used to perform, for each session, the transmitting process and the receiving process with the other communication device relevant to the session. The data transmitting device 101 according to the present embodiment also performs, for each session, the transmitting process and the receiving process with the other communication device 301 relevant to the session.

The writing controller 23 performs a control to write data stored in the storage device 103 in the transmit buffer 104. Any method may be used as a method for the writing control according to the device configuration. For example, the storage device 103 includes therein a build-in DMAC (direct memory access controller) (not shown), and the writing controller 23 may output an instruction signal to the DMAC to cause the DMAC to write the data in the transmit buffer 104. In this case, the writing controller 23 may instruct the DMAC on a write address in the transmit buffer 104. Alternatively, the host CPU 102 itself may read the data from the storage device 103 and write the data in the transmit buffer 104. Alternatively, the writing process may be performed using a dedicated hardware.

Note that the host CPU 102 can perform various processes in addition to the above-described processes.

The data transmitting device 101 performs the transmitting process and the receiving process on data according to TCP/IP on behalf of the host CPU 102. The data transmitting device 101 reads data written in the transmit buffer 104 and performs protocol handling in TCP/IP and the like, for each session. This creates a frame. The created frame is then transmitted to the network 201. Such a data transmitting device 101 includes the session manager 11, the session information storage 12, the data reader 13, and the communication processor 14. The data transmitting device 101 may be formed by either hardware or software (a program), or by both of them.

When receiving the notification of the establishment of connection from the connection processor 22, the session manager 11 registers the ID of a session the connection of which is established. In addition, when receiving the notification of the disconnection, the session manager 11 deletes the ID of the disconnected session. The session manager 11 thereby grasps sessions in a connection established state internally. In the following description, registering or deleting a session ID may be expressed as registering or deleting a session.

The session manager 11 consecutively and cyclically selects each session based on registered session IDs, and outputs instruction information to instruct the communication processor 14 to perform the transmitting process with respect to the selected session. As a method of cyclically selecting a session, for example, a method may be used in which registered session IDs are held in a queue, the session IDs are sequentially read, and the read session ID is enqueued again at the tail of the queue. The queue is stored in an internal or external buffer of the data transmitting device 101.

Alternatively, the ID and the connection state (established or disconnected) of each session established by the connection processor 22 is held in a table, which is held in the internal or external buffer of the data transmitting device 101. A method may be used in which entries in the table are sequentially and cyclically checked to select sessions in the connection established state. In this case, a session being registered in the session manager 11 means that the session ID thereof is registered in the table, the connection state thereof is “established.” Note that methods other than those described here may be used to select a session.

The session information storage 12 stores session information on each session registered by the session manager 11. The session information contains the above-described values of a session (destination IP address, source IP address, destination port number, and source port number), and the other information needed to create a TCP/IP header (e.g., sequence number and acknowledgement number (ACK sequence number)). In addition, an MSS (Maximum Segment Size) may be contained in the session information. The MSS may be separately managed if it is common to all the sessions.

In addition, the session information contains buffer information to specify a position in the transmit buffer 104 at which data for the session is written. The buffer information contains information to specify an address which stores data that has not been transmitted yet in the transmit buffer 104. For example, the buffer information may be a couple of a read pointer indicating the ending address of data that has been read (or the beginning address of data that has not been read yet) and a write pointer indicating the ending address of data that has been written, in the transmit buffer 104. The buffer information may be configured in the other expression forms.

The session information storage 12 may be disposed in the data transmitting device 101, or may be disposed outside the data transmitting device 101 (e.g., in a main memory). The session information may be registered in the session information storage 12 when the session is registered in the session manager 11 (i.e., the session ID is registered), and may be deleted from the session manager 11 when the session is deleted. In addition, the session information in the session information storage 12 may be updated when the transmitting process is performed on the session, or when data relevant to the session is written in the transmit buffer 104. The above-described registration, deletion, and update of the session information are performed by the host CPU 102 or the data transmitting device 101, or may be configured to be performed by either of them.

For example, the session manager 11 of the data transmitting device 101 may create the session information when registering the session ID, and may store the session information in the session information storage 12. Information needed to create the session information may be obtained from the host CPU 102. Alternatively, the connection processor 22 of the host CPU 102 or the other processor may create the session information and stores it in the session information storage 12 when the session is registered in the session manager 11.

Alternately, the session manager 11 of the data transmitting device 101 may delete the session information from the session information storage 12 when deleting the relevant session ID. Alternatively, the connection processor 22 of the host CPU 102 or the other processor may delete the session information from the session information storage 12 when the session ID is deleted from the session manager 11.

Alternatively, when data is written in the transmit buffer 104 under the control of writing controller 23 of the host CPU 102, the relevant session information (e.g., buffer information in session information) may be updated by the host CPU 102 or the data transmitting device 101. Alternately, when the communication processor 14 of the data transmitting device 101 performs the transmitting process, the relevant session information (e.g., buffer information and sequence number) may be updated.

The data reader 13 reads data from the transmit buffer 104 when receiving an instruction to read the data from the communication processor 14. The data reader 13 transmits the read data to the communication processor 14. A read address in the transmit buffer 104 may be calculated from the buffer information in the session information by the communication processor 14 and notified to the data reader 13, or may be calculated from the buffer information by the data reader 13. Alternatively, the buffer information may be separated from the session information to be managed by the data reader 13.

The communication processor 14 performs the transmitting process of data for each session that is cyclically specified from the session manager 11. The communication processor 14 can obtain information such as the position and the size of data in the transmit buffer 104 that has not been transmitted yet by checking the buffer information corresponding to the relevant session. The communication processor 14 can thereby read data from the transmit buffer 104 based on the buffer information to perform the transmission.

Specifically, when receiving the specification of a session to next subject to the transmitting process from the session manager 11, the communication processor 14 obtains the relevant session information, and creates a TCP/IP header from the sequence number, the acknowledgement number, and the port number contained in the session information. In addition, the communication processor 14 instructs the data reader 13 to read the data corresponding to the session. At this point, the communication processor 14 may calculate a read address from the buffer information in the session information and notify the read address to the data reader 13. The communication processor 14 obtains the data read by the data reader 13, and attaches the above-described header, a checksum that is separately calculated, and the like to the obtained data to create a frame. The communication processor 14 transmits the created frame to the network 201.

In addition, the communication processor 14 performs, in addition to the data transmission described here, the process of receiving data from the other communication devices 301, and the process of transmitting or receiving an ACK packet, a FIN packet, an RST packet, and the like. Note that, when receiving the above-described control packets through the network 201, the communication processor 14 passes information on the control packets to the host CPU 102 via a memory such as a main memory. In addition, the communication processor 14 may create control packets based on information passed from the host CPU 102 and transmits the information to network 201. The control packets may be created by the host CPU 102.

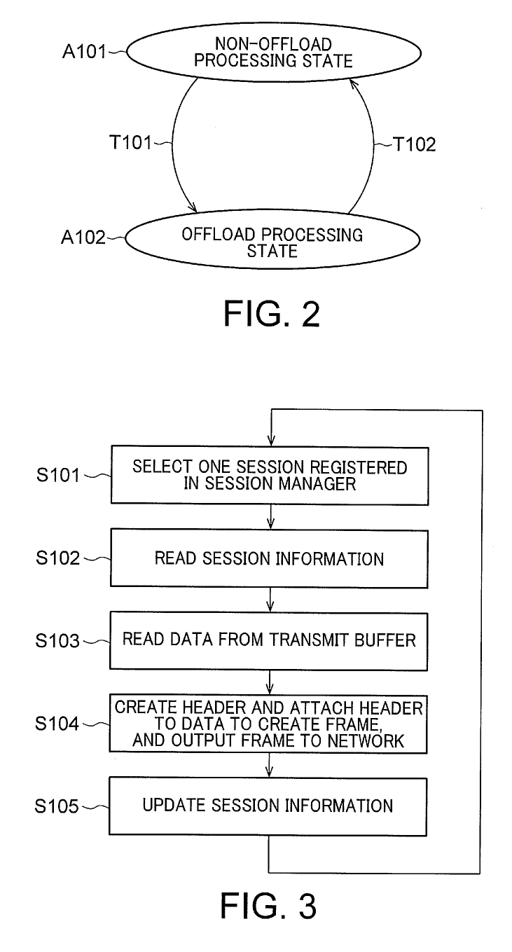

FIG. 2 is a state transition diagram of one session in the data transmitting device 101. The states of the session include a non-offload processing state A101 and an offload processing state A102.

The one session is in the non-offload processing state A101, as an initial state, when the session is created by the connection processor 22. When a connection is established for the session and registered in the session manager 11, the state of the session makes a transition to the offload processing state A102 (T101). In addition, when the session is deleted from the session manager 11, the state of the session makes a shift to the non-offload processing state A101 (T102).

In the offload processing state A102, the relevant session is selected together with the other sessions in the offload processing state A102 sequentially and cyclically (equally) by the session manager 11, and the transmitting process is performed on the relevant session by the communication processor 14. That is, each session in the offload processing state A102 is equally provided with an opportunity of transmission, and can transmit data. In contrast, in the non-offload processing state A101, the session is not registered in the session manager 11, and is provided with no opportunity of transmission.

That is, the host CPU 102 requests the data transmitting device 101 to serve as a proxy to perform the transmitting process on any session by registering the session ID in the session manager 11. The data transmitting device 101 performs the transmitting process in turn equally on the sessions registered in the session manager 11. In addition, the host CPU 102 provides a notification of disconnecting the connection to eliminate the session IDs registered in the session manager 11, which in turn enables the data transmitting device 101 to stop performing the transmitting process on the relevant session.

FIG. 3 is a flow chart of the transmitting process in the data transmitting device 101.

(Step S101) First, the session manager 11 selects one session from among sessions managed by it, and notifies the communication processor 14 to start performing the transmitting process on the session.

(Step S102) The communication processor 14 reads session information corresponding to the session notified by the session manager 11 from the session information storage 12. The communication processor 14 specifies information needed to read data from the read session information, and transmits the specified information to the data reader 13 together with a read instruction. The information needed to read the data may include, for example, a read address in the transmit buffer 104 (buffer information) and an MSS (Maximum Segment Size). If these pieces of information are managed by the data reader 13 internally, the communication processor 14 may be configured to transmit only the read instruction.

(Step S103) The data reader 13 reads the data from the transmit buffer 104 according to the read instruction from the communication processor 14. For example, the data stored in one frame is read.

For example, when the MSS is set to 1460 Bytes, and the transmit buffer 104 has 4 KB of data, only 1460 Bytes of data of 4 KB is read. In another instance, when the MSS is set to 1460 Bytes, and the transmit buffer 104 has 512 Byte of data, the 512 Bytes of data is read. In the present embodiment, it is assumed that one frame is transmitted for each session in one transmitting process, and a predetermined number of frames may be transmitted. In this case, pieces data to be stored in the frame are read by the number of frames. Naturally, if there is no data to be stored in a frame, the number of frames is made smaller than the above predetermined number. That is, the upper limit of the number of frames to be transmitted is common to each session and in each transmitting process.

(Step S104) When receiving the data from the data reader 13, the communication processor 14 creates a header based on the session information, and attaches the header to the data. In addition, the communication processor 14 calculates a checksum from the header and the data, and further adds the calculation result to the data to create the frame. The communication processor 14 outputs the created frame to the network 201.

(Step S105) The communication processor 14 updates the session information corresponds to the session in which the frame is transmitted. For example, the sequence number (transmitted sequence number) in the session information is updated based on the size of the data transmitted this time. In addition, the buffer information in the session information is updated based on an address at which the reading is performed from the transmit buffer 104 this time, or the size of the data transmitted this time. In addition, the values of the other items in the session information are updated as necessary. Note that the buffer information may be updated at the timing when an ACK packet corresponding to the transmitted data is received, taking a retransmission process into consideration.

### (Modification)

In the first embodiment, the communication protocol is assumed to be TCP, and from among sessions having established connections, the session selection is performed in the session manager. When a connectionless protocol such as the UDP is used, established sessions can be simply added as selected objects. This also applies to second and third embodiments, which will be described hereafter.

As described above, in the communication device according to the first embodiment, the transmitting process is performed on the sessions in turn (cyclically) to suppress the variations in the amounts of data to be transmitted among the session in each transmitting process. For example, frames the number of which is equal to or less than the upper limit are transmitted for each session and in each transmitting process. This enables an equal network bandwidth to be allocated to the sessions, which in turn enables the prevention of a burst transmission of frames in a specific session.

### Second Embodiment

In the present embodiment, only a session for which transmit buffer 104 has data is selected as an object to perform the transmitting process from among sessions managed by the session manager 11. In the first embodiment, a session for which data to be transmitted is absent is selected as long as it is registered session manager 11. As a result, when the operation of the transmitting process is performed on a session, since data to be transmitted is absent, data is not transmitted after all, and a read operation, an analysis operation, and the like of session information that have been performed until then are wasted (failed operation). This imposes unnecessary loads on the data transmitting device and the use efficiency of the network bandwidth decreases during the period of the operations. Therefore, the present embodiment resolve this problem by not selecting a session for which data to be transmitted is absent for the transmitting process.

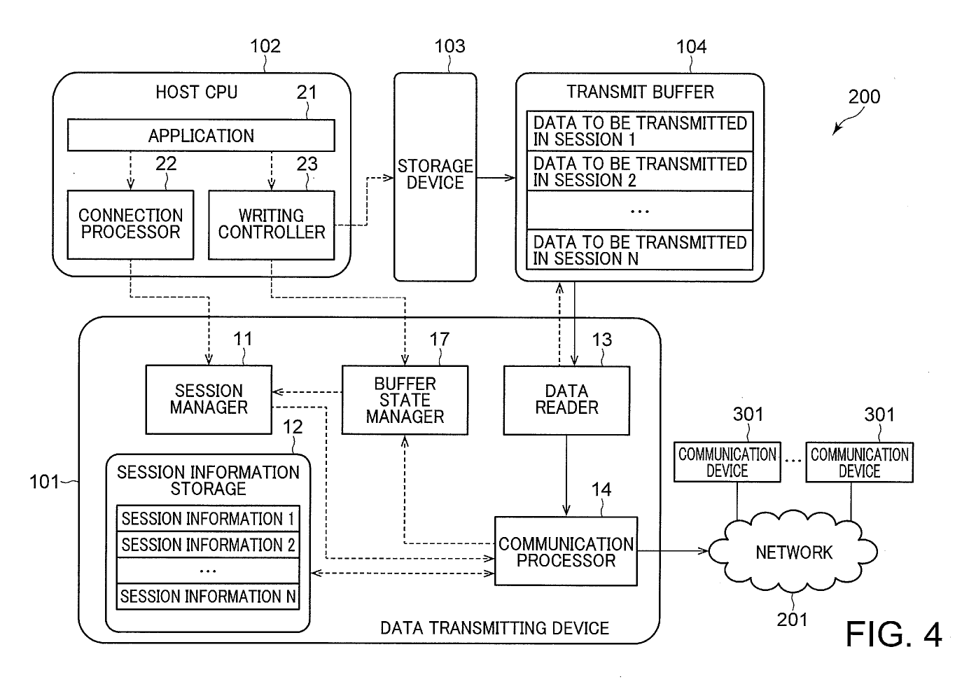

FIG. 4 is a block diagram showing a communication device including a data transmitting device according to a second embodiment. Components having the same names as those in FIG. 1 are denoted by the same reference numerals, and redundant descriptions thereof will be omitted except for extended or altered processes.

The data transmitting device 101 in a communication device 200 of the present embodiment includes a buffer state manager 17, in addition to the processors of the first embodiment. The buffer state manager 17 manages how to set the state with respect to the sessions registered in the session manager 11, according to whether data is stored in the transmit buffer 104.

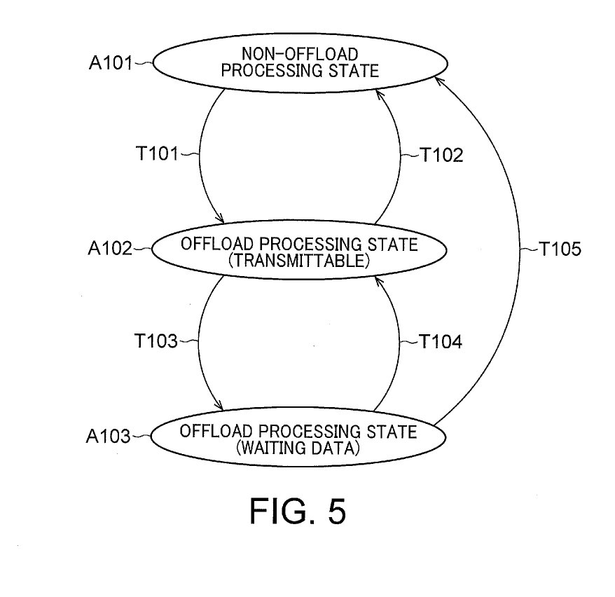

FIG. 5 is a state transition diagram of one session in the data transmitting device 101.

In addition to the non-offload processing state A101 and the offload processing state A102 in the first embodiment, an offload processing state (waiting data) A103 is provided. The offload processing state A102 described in the first embodiment is here denoted by an offload processing state (transmittable) A102 so as to be distinguished from the offload processing state (waiting data) A103. The offload processing state (transmittable) A102 corresponds to a first state of a session and the offload processing state (waiting data) A103 corresponds to a second state of the session.

The offload processing state (waiting data) A103 is a state that, with respect to a session, a connection is established and registered in the session manager 11 and data to be transmitted is absent in the transmit buffer 104. In this state, the session manager 11 does not the session for the transmitting process.

The buffer state manager 17 manages how to set the offload processing state (transmittable) A102 and the offload processing state (waiting data) A103 to each session managed in the session manager 11.

For example, in the offload processing state (transmittable) A102, if the absence of data in the transmit buffer 104 is detected, the communication processor 14 notifies the absence to the buffer state manager 17. When receiving the notification, the buffer state manager 17 sets the offload processing state (waiting data) A103 as the state of the session in the session manager 11 (T103).

Here, the reason of setting the offload processing state (waiting data) A103 rather than the non-offload processing state A101 is that the data transmitting device 101 have to perform a data receiving process or a control-related transmitting/receiving process on an ACK packet, FIN packet, RST packet, and the like with the other communication device 301 even when not transmitting data from the transmit buffer 104. That is, the data transmitting device operates such that the above control-related transmitting/receiving process is performed even when the transmitting process of data is not performed, as long as the session is registered in the session manager 11.

In addition, the writing controller 23 writing data in the transmit buffer 104 under its control notifies the writing to the buffer state manager 17. The buffer state manager 17 receiving the notification changes the state of the relevant session in the session manager 11 from the offload processing state (waiting data) A103 to the offload processing state (transmittable) A102 (T104). Note that the relevant session having already been in the offload processing state (transmittable) A102 is not changed in its state.

In addition, in the offload processing state (waiting data) A103, the session manager 11 receiving the notification of disconnecting a connection from the connection processor 22 deletes the registration of the relevant session. That is, the session manager 11 deletes the session ID of the relevant session. The relevant session thereby makes a transition to the non-offload processing state A101 (T105).

The session manager 11 cyclically selects only sessions in the offload processing state (transmittable) A102, and causes the communication processor 14 to perform the transmitting process on them. This means that the communication processor 14 does not need to perform the transmitting process on a session that has no data in the transmit buffer 104 while having the established connection.

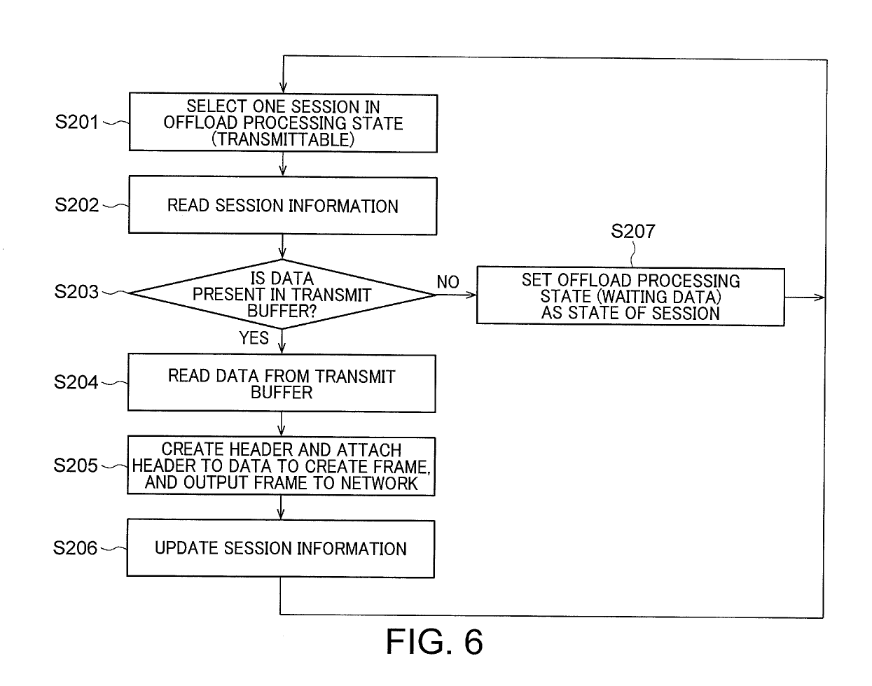

FIG. 6 is a flow chart of the transmitting process in the data transmitting device 101 according to the present embodiment. More specifically, this flow chart shows the flow of a process, which is implemented in the session manager 11, performed on a session in the offload processing state (transmittable) A102.

(Step S201) The session manager 11 selects one session in the offload processing state (transmittable) A102 from among sessions managed by itself, and notifies the communication processor 14 to start performing the transmitting process on the session.

(Step S202) The communication processor 14 reads session information corresponding to the notified session from the session information storage 12. The communication processor 14 specifies information (e.g., buffer information and an MSS) needed to read data from the transmit buffer 104 from the session information.

(Step S203) The communication processor 14 determines whether the transmit buffer 104 has data to be transmitted, based on the specified information. For example, when the buffer information indicates that there is no address to read (e.g., if a read pointer is identical to a write pointer), the communication processor 14 determines that the transmit buffer 104 has no data. Otherwise, the presence of data can be determined.

(Step S207) When determining that the transmit buffer 104 has no data, the communication processor 14 notifies the determination to the buffer state manager 17. The buffer state manager 17 sets the offload processing state (waiting data) A103 as the state of the session. Subsequently, the flow returns to step S201.

(Step S204) On the other hand, when determining that the transmit buffer 104 has data, the communication processor 14 transmits a read instruction, and buffer information and the like as necessary to the data reader 13. The data reader 13 reads data from the transmit buffer 104 by, for example, the size with which the data can be stored in one frame under the read instruction. As with the first embodiment, it is assumed that one frame is transmitted for each session in one transmitting process, and a plurality of frames may be transmitted in one transmitting process.

(Step S205) When receiving the data from the data reader 13, the communication processor 14 creates a header based on the session information, and attaches the created header to the data. In addition, the communication processor 14 calculates a checksum from the header and the data, and further adds the calculation result to the data to create the frame. The communication processor 14 outputs the created frame to the network 201.

(Step S206) After transmitting the frame, the communication processor 14 updates the session information on the relevant session in the session information storage 12. For example, the sequence number (transmitted sequence number) in the session information is updated based on the size of the data transmitted this time. In addition, the buffer information in the session information is updated based on a read address in which the transmitted data this time exists. The buffer information may be updated at the timing when an ACK packet corresponding to the transmitted frame is received, taking the retransmission process into consideration.

In the above-described process, the communication processor 14 determines whether the transmit buffer 104 has data when the transmitting process is started, and whether the transmit buffer 104 has data may be determined made after the completion of the transmitting process. That is, the process of steps S203 in FIG. 6 may be performed after step S205 or S206.

In addition, in the above-described embodiments, the communication processor 14 determines whether the transmit buffer 104 has data, and this determination may be made by the buffer state manager 17. In this case, the buffer state manager 17 receives the notification of the address of new data written in the transmit buffer 104, from the writing controller 23 for each session, and receives the notification of the address of data read from the transmit buffer 104 (or the address of transmitted data for which an ACK packet has been received), from the communication processor 14. The buffer state manager 17 defines, for example, the ending address of the written data as a write pointer and the ending address of the read data as a read pointer, and manages the pointers in the internal or external buffer (memory) of the data transmitting device 101. The buffer state manager 17 can determine whether any unread data is present by comparing these pointers. When the presence of unread data is detected, the state of the relevant session is caused to transition to the offload state (waiting data) A103.

As described above, the communication device according to the second embodiment performs the frame transmitting process sequentially only on sessions which have established connections and for which the transmit buffer 104 has data. This enables the efficient transmission while using the bandwidth equally among the sessions.

### Third Embodiment

In TCP, a communication device on a receiving side notifies the size of data that is receivable at that point to a communication device on a transmitting side as a window size (receive window size). This window size is contained in the header of a data packet or an ACK packet. This receive window size is typically set to the size of an unwritten space in a receive buffer of the communication device on the receiving side.

The communication device on the transmitting side uses receive window size of this communication device on the receiving side as a transmit window size of the communication device on the transmitting side, and controls the transmission (performs a flow control) so as not to transmit data having a size equal to or larger than this transmit window size. This is to prevent buffer overflow in the communication device on the receiving side. The occurrence of an overflow in a receive buffer of the communication device on the receiving side causes the retransmission process of TCP/IP, resulting in more packets transmitted to a network than usual.

In addition, communication devices on a communication route in a network (e.g. relay equipment such as routers) also have buffers, and there is a conceivable risk that these buffers overflow. For this reason, in TCP, the transmitting side performs the transmitting process while limiting the size of data to be transmitted under a congestion control so as not to cause congestion. At this point, the size of data to be transmitted is determined as the congestion window of the transmitting side. According to the congestion control in TCP, the transmitting side starts with an initial congestion window size having a small value, and increases the congestion window size every time receiving an ACK packet (data reaches the receiving side). When the increased congestion window size causes a duplicate ACK or a retransmission timeout, the transmitting side determines that packet loss (congestion) occurs on the communication route due to a buffer overflow or the like, and decreases the congestion window size. In such a manner, TCP performs the transmitting process while limiting the size of data to be transmitted so as to prevent the occurrence of congestion in the network as much as possible. There are various congestion control algorithms, but the present embodiment does not depend on the kinds of the congestion control algorithms and the further description will be omitted.

The communication device on the transmitting side interrupts the transmitting process when one of the transmit window size (receive window size of the other communication device) and the congestion window size becomes equal to or smaller than a certain threshold.

That is, when at least one of the window sizes becomes equal to or smaller than the threshold, the transmission for the session is interrupted. As this threshold, for example, a value such as a MSS is used. The session in which the transmission is interrupted resumes the transmission when an ACK packet is received from the other communication device, the transmit window size (receive window size of the other communication device) and the congestion window size are updated, and both the window sizes exceed the threshold.

As described above, in TCP, since the flow control and the congestion control are performed using the transmit window and the congestion window, the transmission may not be made even when the connection is in the established state and the transmit buffer has data. Performing the transmitting process without the flow control and the congestion control may decrease transfer efficiency. For example, under a state where the receive buffer of the receiving side (other communication device side) or the like has an extremely small size, when data is transmitted with the transmit window having a size equal to or smaller than the above threshold, there is a risk that the transfer efficiency is decreased and the transmission cannot be made at a maximum rate. In addition, in the case where congestion occurs on the communication route of a session, when data is transmitted with the congestion window having a size equal to or smaller than the above threshold, there is similarly the risk that the transfer efficiency is decreased and the transmission cannot be made at a maximum rate. In addition, if the transmitting process shown by the flow chart of the first or second embodiment is performed in the state that the flow control and the congestion control are performed, and the operation of the transmitting process is performed on a session for which the transmission is limited under the flow control and the congestion control, data is not transmitted after all and the read operation, analysis operation, and the like of session information that have been performed until then are wasted (failed operation). This imposes unnecessary loads on the data transmitting device and the use efficiency of the network bandwidth decreases during the period of the operations. Therefore in the third embodiment, sessions to perform the transmitting process are determined taking the states of the flow control and the congestion control into consideration.

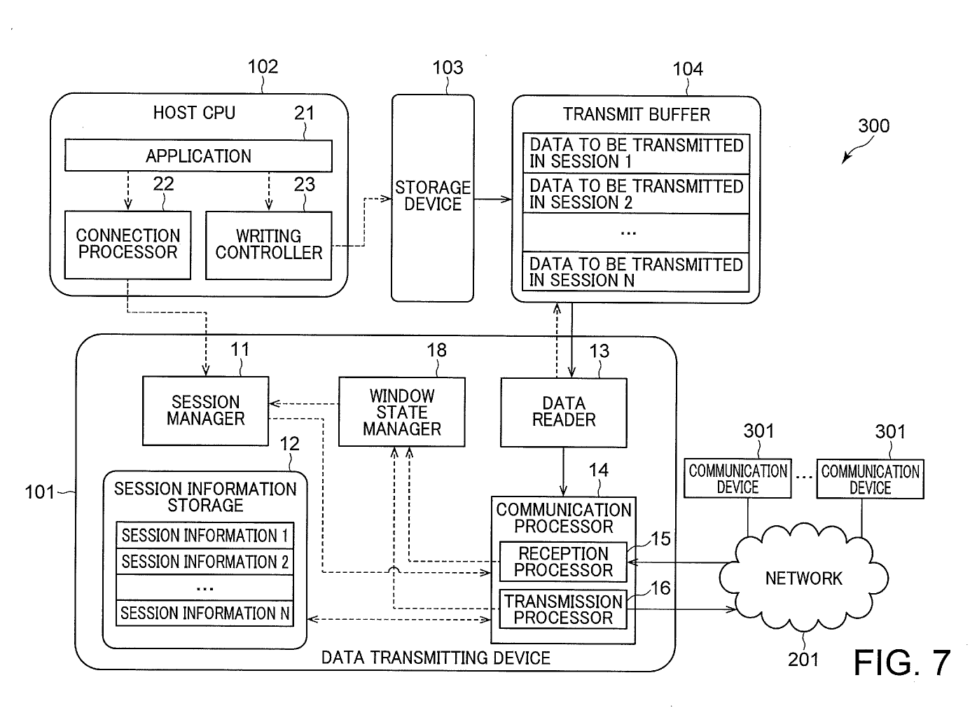

FIG. 7 is a block diagram showing a communication device including a data transmitting device according to the third embodiment. Components having the same names as those in FIG. 1 are denoted by the same reference numerals, and redundant descriptions thereof will be omitted except for extended or altered processes.

The communication processor 14 of a communication device 300 includes a transmission processor 16 that performs the transmitting process and a reception processor 15 that performs the receiving process. The communication processor 14 has a function of performing the congestion control algorithm of TCP. Note that although the communication processor 14 includes the processor that performs the transmitting process and the processor that performs the receiving process in the first and second embodiments, they are explicitly described in the present embodiment.

The data transmitting device 101 of the present embodiment includes a window state manager 18, in addition to the processors of the first embodiment. The window state manager 18 performs a control on how to set the state of a session managed by the session manager 11 according to the states of the transmit window and the congestion window (i.e., the states of the flow control and the congestion control).

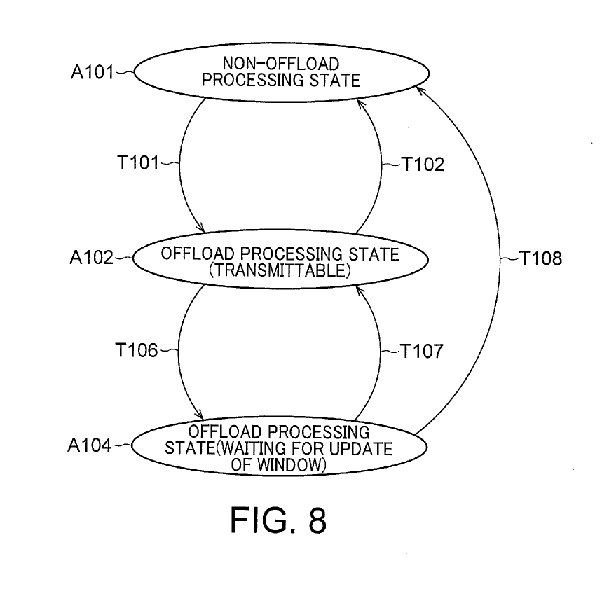

FIG. 8 is a state transition diagram of one session in the data transmitting device 101.

In addition to the non-offload processing state A101 and the offload processing state A102 in the first embodiment, an offload processing state (waiting for the update of a window) 104 is provided. The offload processing state described in the first embodiment is denoted by the offload state (transmittable) A102 so as to be distinguished from the offload processing state (waiting for the update of a window) 104. The offload processing state (transmittable) A102 corresponds to the first state of a session, and the offload processing state (waiting for the update of a window) A104 corresponds to the second state of the session.

The offload processing state (waiting for the update of a window) 104 is a state that a connection is established and registered in the session manager 11 and at least one of the window sizes of the transmit window and the congestion window is equal to or smaller than the threshold. A state that the window size of the transmit window is equal to or smaller than the threshold may be expressed as “the transmit window is closed,” and a state that the size is larger than the threshold may be expressed as “the transmit window is opened.” A state that the window size of the congestion window is equal to or smaller than the threshold may be expressed as “the congestion window is closed,” and a state that the size is larger than the threshold may be expressed as “the congestion window is opened.” The threshold value of the transmit window may be identical to or different from the threshold value of the congestion window. For example, a MSS may be used for both the threshold values. A session having a closed window is not selected by the session manager 11, and the transmitting process is not performed on the session.

The window state manager 18 manages how to set the offload processing state (transmittable) A102 and the offload processing state (waiting for the update of a window) A104 to each session registered in the session manager 11.

For example, with respect to a session in the offload processing state (transmittable) A102, if detecting the close of the window at the time of starting the transmitting process, the transmission processor 16 notifies the detection to the window state manager 18. The window state manager 18 receiving the notification causes the state of the relevant session to transition to the offload processing state (waiting for the update of a window) A104 (T106). The reason of the transition to the offload processing state (waiting for the update of a window) A104 rather than the non-offload processing state A101 is that the data transmitting device 101 have to perform a data receiving process or a transmitting/receiving process on an ACK packet, FIN packet, and RST packet with the other communication device 301 even when not transmitting data from the transmit buffer 104. That is, the data transmitting device operates such that the above control-related transmitting/receiving process is performed even when the transmitting process of data is not performed, as long as the session is registered in the session manager 11.

In contrast, in the offload processing state (waiting for the update of a window) A104, when the reception processor 15 receives an ACK packet from the other communication device 301, and the sizes of transmit and congestion windows are updated (they may be maintained at an identical value) according to the window size in the TCP packet and the congestion algorithm of TCP, the data transmitting device 101 compares the window sizes with respective thresholds. When the both sizes become larger than the threshold, the reception processor 15 notifies the comparison result to the window state manager 18. The window state manager 18 receiving the notification causes the state of the relevant session to transition to the offload processing state (transmittable) A102 (T107). Alternatively, upon receiving the ACK packet the data transmitting device 101 may cause the transition to the offload processing state (transmittable) A102 without checking whether the window sizes are larger than the threshold. This is because the window sizes are more likely to be updated when the ACK packet is received, and thus the transition to the offload processing state (waiting for the update of a window) A104 can be made again in the next transmitting process even if the transition to the offload processing state (transmittable) A102 is made while any one of the window sizes remains equal to or smaller than the threshold.

In addition, in the offload processing state (waiting for the update of a window) A104, the session manager 11 receiving the notification of disconnecting a connection from the connection processor 22 deletes the registration of the relevant session. That is, the session manager 11 deletes the session ID of the relevant session. The relevant session thereby makes a transition to the non-offload processing state A101 (T108).

The values of the transmit window size and congestion window size may be managed contained in the session information of each session. For example, when new values of the transmit window size and the congestion window size are obtained due to, the reception of an ACK packet in the reception processor 15, or the like, the updated values may be written (overwritten) in the session information of the relevant session.

Alternately, the window state manager 18 may compare the window sizes in the session information with the respective thresholds periodically or at the time of the occurrence of any event, and may perform a control on how to set the state of the session according to the above-described determination method. A conceivable trigger as the any event is, for example, a notification that the communication processor provides to the window state manager 18 when at least one of the window sizes in the session information is updated, although this does not limit the any event.

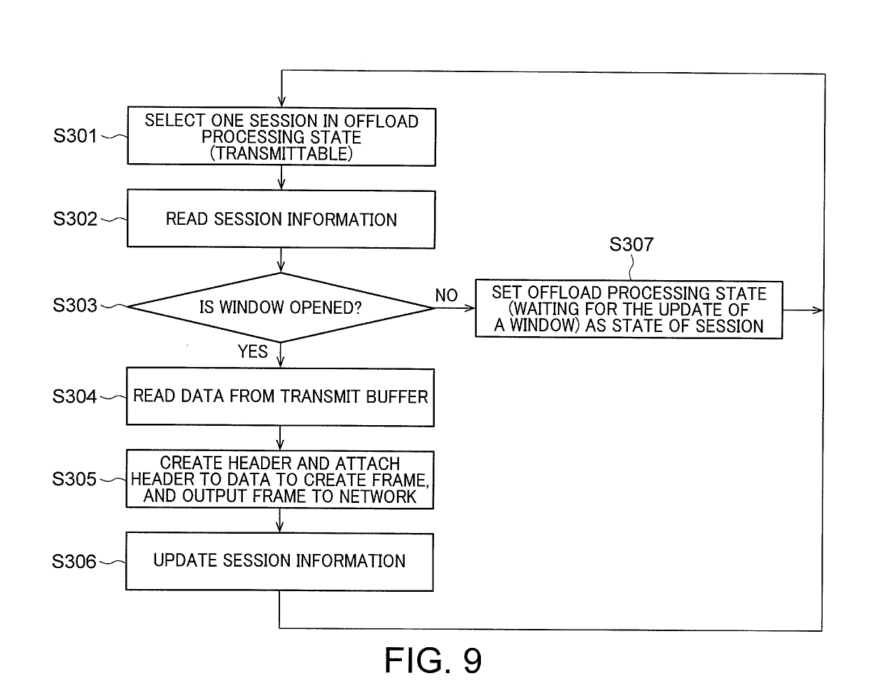

FIG. 9 is a flow chart of the transmitting process in data transmitting device 101 according to the present embodiment. More specifically, this flow chart shows the flow of a process, which is implemented in the session manager 11, performed on a session in the offload processing state (transmittable) A102.

(Step S301) The session manager 11 selects one session in the offload processing state (transmittable) A102 from among sessions managed by itself, and notifies the communication processor 14 to start performing the transmitting process on the session.

(Step S302) The transmission processor 16 of the communication processor 14 read session information corresponding to the notified session from the session information storage 12.

(Step S303) The transmission processor 16 determines whether the transmit window and the congestion window are opened, from the values of the sizes of the transmit window and the congestion window contained in the session information. That is, it is determined whether the values of the window sizes are both greater than the threshold value.

(Step S307) When at least any one of the windows is closed, that is, at least one of the values of the window sizes is equal to or less than the threshold value, the transmission processor 16 notifies the closure to the window state manager 18. The window state manager 18 sets the offload processing state (waiting for the update of a window) A104 as the state of the relevant session. Subsequently, the flow returns to step S301.

(Step S304) In contrast, when the both windows are open, the transmission processor 16 transmits a read instruction, and buffer information and the like as necessary to the data reader 13. The data reader 13 read data from the transmit buffer 104 by, for example, the size with which the data can be stored in one frame under the read instruction. As with the first embodiment, a plurality of frames may be transmitted in one transmitting process. Note that an upper limit of the size of read data is a minimum value of the transmit window size or the congestion window size.

(Step S305) When receiving the data from the data reader 13, the transmission processor 16 creates a header based on the session information, and attaches the created header to the data. In addition, the transmission processor 16 calculates a checksum from the header and the data, and further adds the calculation result to the data to create the frame. The transmission processor 16 outputs the created frame to the network 201.

(Step S306) After transmitting the frame, the transmission processor 16 updates the session information on the relevant session in the session information storage 12. For example, the sequence number (transmitted sequence number) in the session information is updated based on the size of the data transmitted this time. In addition, the buffer information in the session information is updated based on an address at which the data transmitted this time is read.

Note that when receiving an ACK packet or the like from the other communication device, the reception processor 15 updates the transmit window size and the congestion window size in the session information. When both the window sizes exceed the thresholds from the state of being equal to or smaller than the thresholds, the reception processor 15 notifies the excess to the window state manager 18. The window state manager 18 receiving the notification updates the state of the relevant session to the offload processing state (transmittable).

In the above-described embodiments, the transmitting process is controlled using both the transmit window and the congestion window, and the control may be performed using only one of the windows. For example, if the transmit window size is larger than the threshold when the transmit window is used, the state of the session is set to the offload processing state (transmittable), and the session is made an object of the transmitting process. When the size is equal to or smaller than the threshold, the state is set to the offload processing state (waiting for the update of a window), and the session is not made the object of the transmitting process. Similarly, if the congestion window size is larger than the threshold when the congestion window is used, the state of the session is set to the offload processing state (transmittable), and the session is made the object of the transmitting process. When the size is equal to or smaller than the threshold, the state is set to the offload processing state (waiting for the update of a window), and the session is not made the object of the transmitting process.

As described above, the communication device according to the third embodiment sequentially and cyclically performs the transmitting process only on sessions which have opened windows among sessions having established connections. This enables the efficient transmission while using the bandwidth equally among the sessions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A data transmitting device that communicates with a plurality of other communication devices through a network, comprising:
a session manager that sequentially and cyclically selects a plurality of sessions relevant to the other communication devices; and
a communication processor that performs a transmitting process of data to the other communication device relevant to the session selected by the session manager in each time each of the sessions is selected so as to suppress variations in amounts of transmitted data among the sessions with respect to an amount of data transmitted per one transmitting process.

2. The data transmitting device according to claim 1, wherein the communication processor transmits a frame containing the data to the other communication device, and an upper limit of the number of frames to be transmitted is identical among the sessions with respect to a number of frames transmitted per one transmitting process.

3. The data transmitting device according to claim 1, wherein the session manager does not select the session when data relevant to the session is absent in a transmit buffer that stores data for transmission relevant to the session.

4. The data transmitting device according to claim 3, further comprising
a buffer state manager that sets a first state to the session when the data relevant to the session is present in the transmit buffer that stores the data for transmission relevant to the session, and sets a second state when the data is absent, wherein
the session manager selects the session from the sessions to which the first state is set, and does not select any of the sessions to which the second state is set.

5. The data transmitting device according to claim 1, wherein the communication processor does not select the session when a value of a transmit window size of the session is equal to or less than a threshold value.

6. The data transmitting device according to claim 5, further comprising
a window state manager that sets a first state to the session when the value of the transmit window size of the session is greater than the threshold value, and sets a second state when the value is equal to or less than the threshold value, wherein
the session manager selects the session from the sessions to which the first state is set, and does not select any of the sessions to which the second state is set.

7. The data transmitting device according to claim 6, wherein
the communication processor receives an acknowledge packet relevant to the session from the other communication device, and
the session manager sets the first state as a state of the session regardless of the value of the transmit window size when the communication processor receives the acknowledge packet.

8. The data transmitting device according to claim 1, wherein the communication processor does not select the session when a value of a congestion window size of the session is equal to or less than a threshold value.

9. The data transmitting device according to claim 8, further comprising
a window state manager that sets a first state to the session when the value of the congestion window size of the session is greater than the threshold value, and sets a second state when the value is equal to or less than the threshold value, wherein
the session manager selects the session from the sessions to which the first state is set, and does not select any of the sessions to which the second state is set.

10. The data transmitting device according to claim 9, wherein
the communication processor receives an acknowledge packet relevant to the session from the other communication device, and
the session manager sets the first state as the state of the session regardless of the value of the congestion window size when the communication processor receives the acknowledge packet.

11. The data transmitting device according to claim 1, further comprising:
a transmit buffer that stores data for transmission for each session; and
a data reader that reads the data from the transmit buffer, wherein
the communication processor outputs an instruction to read data to the data reader for each session, and transmits the data read by the data reader to the other communication device.

12. The data transmitting device according to claim 1, wherein the plurality of sessions are sessions that have connections established with the plurality of other communication devices, respectively.

13. The data transmitting device according to claim 1, wherein the communication processor communicates with the other communication devices according to TCP/IP.

14. A data transmitting method that communicates with a plurality of other communication devices through a network, comprising:
sequentially and cyclically selecting a plurality of sessions relevant to the plurality of other communication devices; and
performing a transmitting process of data to the other communication device relevant to the selected session in each time each of the sessions is selected so as to suppress variations in amounts of transmitted data among the sessions with respect to an amount of data transmitted per one transmitting process.

15. A communication device comprising:
a host CPU that creates sessions for a plurality of other communication devices; and
the data transmitting device according to claim 1.

16. The communication device according to claim 15, wherein
the host CPU includes a connection processor that controls establishing and disconnecting connections with the other communication devices with respect to the sessions, wherein
when establishing the connection, the connection processor notifies an identifier of the session for which the connection is established to the data transmitting device, and
the session manager of the data transmitting device selects the session based on the identifier notified from the host CPU.
